(19) United States
(12) Patent Application Publication
(10) Pub. No.: US 2009/0268443 A1
(43) Pub. Date: Oct. 29, 2009

(54) Replacement battery cap for firearm optic

(75) Inventors: Jeffery Scott Ifland, Jefferson City, MO (US); Matthew Brooks Daniel, Jefferson City, MO (US)

Correspondence Address: Jasen S. Matyas, Suite 204, 302 Campusview Drive, Columbia, MO, 65201, US

(73) Assignee: Slolum L.L.C., Jefferson City, MO (US)

(21) Appl. No.: 12/381,546

(22) Filed: Mar. 13, 2009

Related U.S. Application Data
(60) Provisional application No. 61/070,123, filed on Mar. 20, 2008.

(51) Int. Cl. F21L 4/04

(52) U.S. Cl. 362/205

(57) ABSTRACT

A replacement battery cap assembly for any firearm optic that is powered by a battery, a preferred embodiment of the replacement cap device, including a housing to secure the battery in the battery compartment of the optic connected to the remote switch.

### CROSS-REFERENCE TO RELATED APPLICATIONS

This application claims the priority of Provisional Application Ser. No. 61/070,123 filed on Mar. 20, 2008.

### STATEMENT REGARDING FEDERALLY SPONSORED RESEARCH FOR DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to any firearm optic that is powered by a battery, such as an illuminated dot rifle scope. These firearm optics are widely used in military, law enforcement and hunting situations. In the current state-of-the-art, battery-powered firearm optics can only be turned on and off via a switch on the body of the optic itself.

The invention provides a replacement battery cap connected to a remote switch that could be used to turn the firearm optic's power on or off without requiring the user to reach up to the body of the optic. The invention can replace the original battery cap and the remote switch on the invention can be mounted on the firearm in such a way that the switch could be turned on while the user was holding the firearm in virtually any position. This would allow the user to activate the optic and fire the weapon without reaching up to activate the switch on the body of the optic. As a result, a shot can be fired more quickly when using the invention.

### BRIEF SUMMARY OF THE INVENTION

The invention has many benefits over the prior art. Currently, the user of a battery powered firearm optic has two choices (1) keep the optic's power on at all times that the firearm might be used or (2) reach up to the optic to turn the power on immediately before aiming and firing. The invention provides a more user friendly means for activating the firearm optic. It gives the user the ability to conserve battery life on the optic without negatively affecting the user's ability to aim and fire quickly. For example, a user could mount the remote switch on the grip of a rifle. Then the user could easily turn on the optic with his or her thumb while he or she raises the rifle to his or her shoulder. The user can then pull the trigger and fire upon his or her target without stopping to turn on the optic. This advantage would be highly desirable in any situation where time is of the essence including military operations, law enforcement and other tactical situations as well as in certain hunting situations.

The invention could be offered by the optic manufacturer as a stock component or it could be available as an after market replacement for the battery cap on the optic. In fact, most or perhaps all the battery powered optics currently on the market would accept the invention similar to the exemplary embodiment described herein. Whether a remote switch is built in or is an after market modification to an optic it will comprise some variation of components described below.

### BRIEF DESCRIPTION OF THE SEVERAL VIEWS OF THE DRAWING

The novel features believed to be characteristic of the present invention, together with further advantages thereof will be better understood from the following description and in connection with the accompanying drawings in which the preferred embodiment of the invention is illustrated by way of example. It is to be expressly understood, however, that the drawings are for the purpose of illustration and description only and are not intended as the definition of the limits of the invention.

FIG. 1 is a view of a firearm optic with the replacement battery cap attached.

FIG. 2 is a top view of the replacement battery cap.

FIG. 3 is a view of the underside of the replacement battery cap.

FIG. 4 is an exploded view of the components which comprise the replacement battery cap assembly.

### DETAILED DESCRIPTION OF THE PREFERRED EMBODIMENT

The ensuing description provides one exemplary embodiment only, and is not intended to limit the scope, applicability or configuration of the invention. Rather, the ensuing description of the exemplary embodiment will provide those skilled in the art with an enabling description for implementing an exemplary embodiment of the invention. It should be understood that various changes may be made in the function and arrangement of the elements without departing from the spirit and scope of the invention.

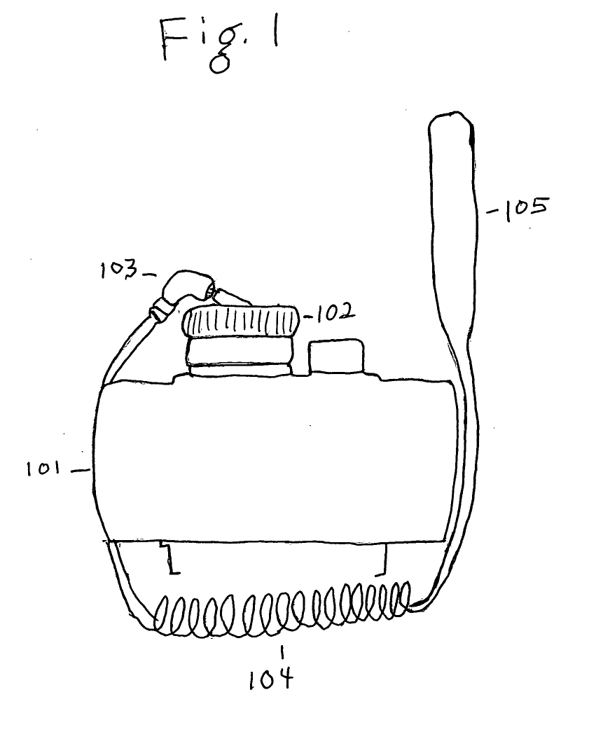

FIG. 1 shows a replacement battery cap assembly 102 attached to a firearm optic 101 with a remote switch 105 attached to the cap device by a wire 104 and the plug 103 for connecting the wire to the replacement cap device. The replacement battery cap assembly 102 replaces the standard cap that is on the optic and secures the power source, generally a round wafer-shaped, watch-type battery, to the optic. On most, or perhaps all, firearm optics the replacement battery cap assembly can be secured to the optic via threads on the outside of the battery compartment of the optic and on the inside of the replacement battery cap assembly which are screwed together in much the same way as a bottle cap on a soft drink bottle.

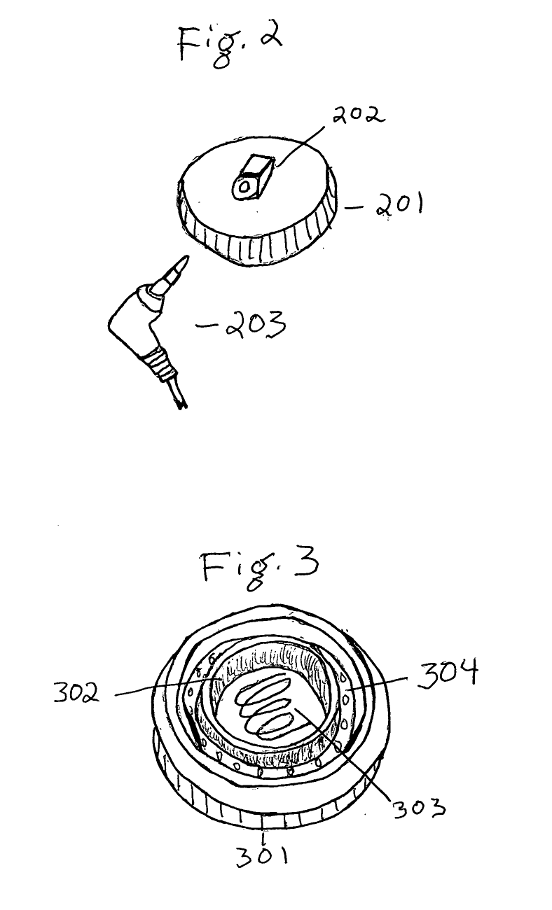

FIG. 2 shows the top view of the replacement battery cap assembly. This view shows the preferred embodiment comprising, in part, the female connection 202 for transmitting the electric current from the battery housed within the cap device 201 to the remote switch. This is accomplished by plugging the male portion 203 to the female portion thereby connecting the battery to the wire 104 and ultimately to the remote switch 105.

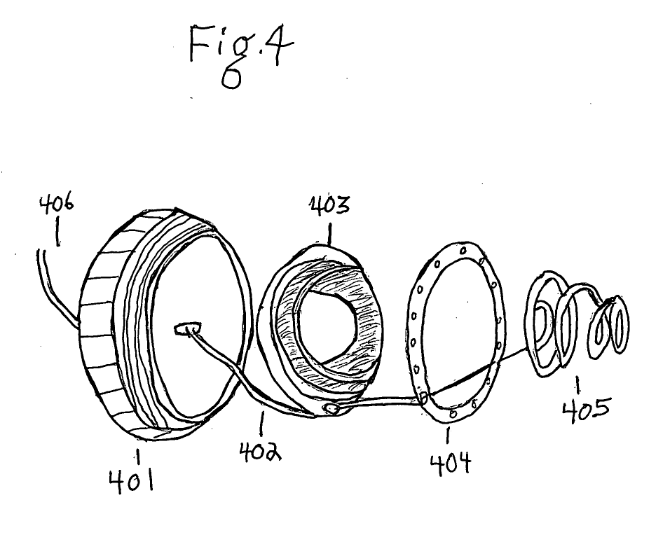

FIG. 3 shows the view from underneath the replacement battery cap assembly. This is where the battery is housed. The battery sits inside of the isolation ring 302 which is made of a material which does not conduct electricity and prevents the battery from touching the conductive surfaces inside of the battery compartment and thereby prevents completion of the circuit within the optic itself even when the power is turned on. Instead, the circuit is diverted through the wire and to the remote switch as follows. The negative terminal of the battery contacts the tension spring contact 303 which in turn is connected via wire to the female connection device 302. The metal contact ring 304 connects with the positive terminal of the battery. This setup allows the optic to be kept in the ON position. but interrupts the circuit so that the optic is not powered on unless the remote switch 105 is engaged.

FIG. 4 shows an exploded view of the components comprising the replacement battery cap assembly. The replacement cap cover 401 is threaded onto the optic body to secure and protect the battery compartment from rain and other elements. In the center of the cover 401 there is a wire or other means of conducting electricity that is attached to the female connection 202 and the negative contact tension spring 405. This wire runs through the non-conductive isolation ring. The positive contact ring 404 is placed on the outside of the non-conductive isolation ring. Again, this configuration allows for a wafer-like watch-type battery to be secured within the existing battery compartment of a firearm optic and interrupts the electrical circuit of the optic when the optic is left in the ON position until the remote switch is engaged.

We claim:

1) A replacement cap device for a firearm optic is powered by a battery, the replacement cap device comprising: a housing for isolating and securing the battery inside the optic battery compartment and to divert electrical current from the battery to a remote switch when the optic itself has its power switch in the “ON” position.

2) A replacement cap device according to claim 1, wherein: said remote switch comprises a tape switch.

3) A replacement cap device according to claim 1, wherein: the replacement cap further comprises an isolation ring made of a material that does not conduct electricity as the means to prevent the battery from contacting any conductive surfaces on the sides of the battery compartment.

4) A replacement cap according to claim 1 or 3, wherein: the replacement cap further comprises a metal contact tension spring to contact the negative terminal of the battery.

5) A replacement cap according to claim 1, 3 or 4, wherein: said tension spring is connected to a female plug on the top of the replacement cap device which allows for a male connection to connect the cap device to the remote switch.

6) A replacement cap device according to claim 1, 3, 4 or 5, wherein: said remote switch comprises a tape switch.

7) A replacement cap device according to claim 1, 3, 4, 5 or 6, wherein: said wire connecting the remote switch to the replacement cap device is a spiral coiled wire.
